(19) United States
(12) Patent Application Publication
(10) Pub. No.: US 2006/0290470 A1
(43) Pub. Date: Dec. 28, 2006

(54) Enhanced valet function for automobiles

(76) Inventors: Charles A. Massoll, Milford, MI (US); Scott P. Geisler, Clarkston, MI (US); Robert B. Powers, Orthonville, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/159,644

(22) Filed: Jun. 23, 2005

(51) Int. Cl. G05B 19/00; H04Q 1/00

(52) U.S. Cl. 340/5.74; 340/5.72

(57) ABSTRACT

Methods and apparatus are provided for determining access to private stored in an automobile. The apparatus comprises a means for identifying user classification. The apparatus further comprises a means for selecting an information access state based on the user classification. The apparatus further comprises a means for restricting access to private data based, at least in part, on the information access state.

### TECHNICAL FIELD

The present invention generally relates to the field of automotive security, and more particularly relates to an enhanced valet function for automobiles.

### BACKGROUND OF THE INVENTION

Modern automobiles can include a multitude of electronic devices that can store personal information. For example, an automobile navigation system can include the address of the owner's home, as well as addresses of locations that the owner visits. Other personal information that can be stored in an automobile can include the owner's contact list of individual addresses and phone numbers. In addition to personal information, automobiles can also contain a myriad of personal settings such as air conditioning settings, radio preset settings, electric seat position settings, and the like.

Because of the sensitive nature of the personal information stored in the automobile, it would be advantageous to have the ability to secure the information when the automobile is used by someone other than the owner or authorized operator. For example, address and phone number information should not be useable or accessible to a worker at a car wash or to a valet at a restaurant. Therefore, access to onboard electronics, such as the navigational system, should be prohibited to the individuals. However, there are times when it would be advantageous to grant certain users partial access to onboard electronic devices while preventing the change and modification of personal information.

Currently, systems exist in which access to the glove box and automobile trunk can be prevented through the use of a valet key that can be used to start the automobile but can not be used to open the glove box or trunk. This solution, however, provides no protection for the personal information stored on onboard electronics.

Accordingly, it is desirable to provide an enhanced valet function for an automobile that allows restricted access to private data. In addition, it is desirable to provide an enhanced valet function for an automobile that can set different levels of security depending on the user. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

An apparatus is provided for determining access to private data in an automobile. The apparatus comprises a means for identifying user classification. The apparatus further comprises a means for selecting an information state based on the user classification. The apparatus further comprises a means for restricting access to private data based, at least in part, on the information state.

A method is also provided for restricting access to private data in an automobile. The method comprises, in a first step, identifying a user classification. Next, an information state of an automobile information security system is set based on the user classification. Then, access is granted to private data based, at least in part, on the information state.

### DESCRIPTION OF THE DRAWINGS

The present invention will hereinafter be described in conjunction with the following drawing figures, wherein like numerals denote like elements, and

FIG. 1 illustrates a block diagram of an exemplary computer system for use in an automobile; and

FIG. 2 is a flowchart of an exemplary embodiment of the present invention.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

In one exemplary embodiment of the present invention, access to private data that is stored on an automobile is restricted depending on user classification. Private data can be any personal information or user specific information stored in any location in an automobile, such as personal information concerning the owner or any other operators of the automobile stored in an onboard navigational system. Personal information can include addresses, phone numbers and other information. In one exemplary embodiment, private data can also include personal settings related to an automobile such as radio presets, seat position, air conditioning settings and the like. In one exemplary embodiment of the present invention, an automobile can be in one of several states, depending on the classification of the user. For a driver that has full access to all onboard electronics and private data, the automobile can be in a normal state. For a driver that should not have access to private data, such as a valet or automobile wash attendant, the automobile may be in a lockdown state. For users that fall in between having full access to personal data and those who are denied access, the automobile could be placed in an enhanced valet state. An enhanced valet state contains restrictions on access to private data but is not as restrictive as the lockdown state. In addition to restricting access to personal data, access to onboard media such as CDs or DVDs can be restricted and certain automobile performance abilities can also be restricted, such as second or third gear starts, for an automobile in the lockdown or enhanced valet state.

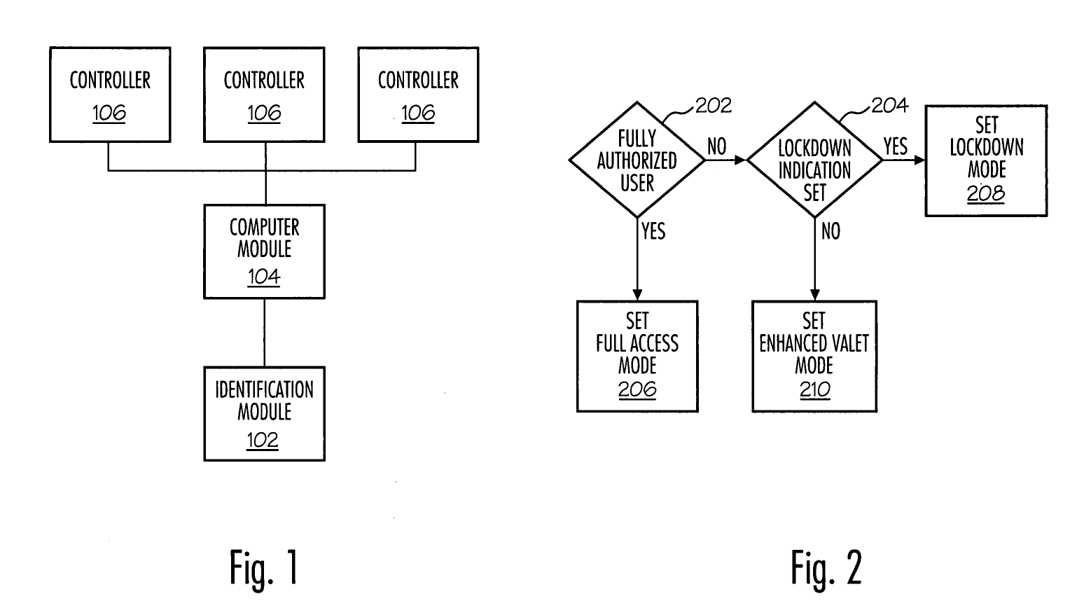

FIG. 1 is a block diagram of an exemplary system 100 for controlling access to personal information in an automobile. System 100 includes a user identification module 102 that determines an user classification. User identification module 102 can be any device that can determine an identification number or other indicator of the user. The user identification module 102 is coupled to a computer module 104, which supports the execution of programs and routines including programs that identify the classification of a user and sets a security level of an automotive security system based on the classification. The computer module 104, which can be of conventional design, couples to one or more component controllers 106 that control various components, such as the navigational system, the entertainment system, and the like.

The system 100 as illustrated in FIG. 1 is exemplary only. The functionality of the various parts can be implemented with fewer or more components. The controllers 106 can be implemented as a single controller or multiple controllers or as part of the processor. Alternative, the controllers 106 can be integrated as part of the component under control.

FIG. 2 illustrates an exemplary method for providing an enhanced valet function for an automobile. In a first step, step 202, system 100 determines if the user should be granted full access. In one exemplary embodiment of the present invention, this can typically be done by using the user identification module 102 to determine if the user is authorized for full access based on an indicator associated with the user. In one exemplary embodiment, the indicator can be stored in the key used by the operator. For example, the indicator can be an identification code stored on a key capable of storing retrievable information, such as an identification code stored on a currently available transponder key. When the transponder key is placed in the ignition system and turned to the “on” or “accessory” position, the identification code can be read by the user identification module 102 and provided to the computer module 104 for authentication. Keys that allow an operator full access to all private data can have a specific identification number, while a key that is to be used by operators with restricted access can have a different identification number, such as a valet key having a particular identification number.

In one exemplary embodiment, the identification number of the key can be read without the need to place the key in the ignition. For example, the automobile and key or key fob may establish a wireless link over which the identification number of a key or key fob can be read using a wireless protocol such as the well-known BLUETOOTH protocol. Alternatively, the wireless link can be established using a cellular communication system. While an identification number stored on a key can be used to determine the classification of a user, other indicators can also be used such as an identification code stored in a key fob, a code entered into an exterior keypad, a biometric system, or some other method of identifying the user. Thus, the exact method of identifying the user is unimportant as long as the user is properly identified in the end.

If the user in step 202 is determined to be authorized for full access, then in step 204, the automobile is placed in a normal state and all automotive functions behave normally. For example, in the normal state, the operator would have full access to both view and modify private data. The user would also have full access to all onboard systems.

If, in step 202, the computer module 104 determines that the indicator is not associated with a fully authorized user, then in step 206, the computer 104 determines if the automobile should be placed in a lockdown state. A lockdown state, in one exemplary embodiment, is set if a lockdown indicator is set and the user is recognized as not authorized for full access in step 202. The lockdown indicator can be a physical switch located in a hidden, un-accessible or non-obvious place, such as a switch located in a securable glove box. Alternatively, the lockdown indicator can be provided using electronic means such as using a voice recognition system, the detection or non-detection of a wireless device, such as a specialized key fob; and the like. In another embodiment, the functionality of the lockdown indicator can be replaced via calling a provider of an in-automobile safety service, such as the well known ONSTAR® system, and requesting the setting of the lockdown indicator or the placing of the automobile in the lockdown state. If the computer module 104 determines that the user is not authorized for full access, as discussed in conjunction with step 202, and the lockdown indicator is not set, then the automobile is placed in an enhanced valet state.

Therefore, in step 206, if the computer module 104 determines that the automobile is not in a lockdown state, the automobile enters the enhanced valet state in step 208. In this state, in one exemplary embodiment, the user may view private data, but is restricted from modifying personal setting or any personal information. The restrictions concerning private data can be accomplished, in one exemplary embodiment, via information sent from the computer module 104 to various component controllers 106. For example, when in an enhanced valet state, the component controller 106 for the navigational system may allow information to be viewed but not modified. In addition, in one exemplary embodiment, media such as that used in an on-board entertainment system or navigation system can not be removed or new media can not be loaded.

The settings discussed above are for exemplary purposes only. What functionalities are disabled when the automobile is in the enhanced valet state can, in one exemplary embodiment, be selected via an owner/operator with full access to the automobile electronics. In another embodiment, the settings can be preset by the manufacturer. In yet another embodiment, the settings can be changed by a dealer or other factory authorized person. For example, an owner may decide to allow an operator with enhanced valet access privileges to load CDs into the entertainment system. The owner may want to do this to allow a relative to use the CD player in the automobile, but restrict alterations to personal settings or personal information. The settings can be customized, in one exemplary embodiment, through an interface associated with the entertainment system, navigational system or any other system capable of receiving a user selection and input.

If the computer module 102 determines that the automobile should be in a lockdown state in step 206, the automobile is placed in the lockdown state in step 210. In one exemplary embodiment of the present invention, when in a lockdown state, substantially all of the prohibitions of the enhanced valet state can be in place. However, additional restrictions can also be included in the lockdown state. For example, instead of just prohibiting the modification of address or navigational information, addresses and phone numbers stored on the system, the viewing of such information can be prohibited. Also, instead of prohibiting the removal of media, in the lockdown state, the use of such media can be prohibited. Other restrictions can also be applied in the lockdown state, such as the use of any short range wireless devices. Again, in one exemplary embodiment, the selection of what is restricted in the lockdown state is can by the authorized user, preset by the manufacturer or set by an authorized factory representative.

In one exemplary embodiment, users who have reason to access a restricted system can be provided with the capability to bypass the enhanced valet state or the lockdown state to access the system. For example, if an automobile service provider is given only a valet key, but needs to access the navigational system for repair, the automobile service provider could have a physical key or other device that can be attached to the automobile system to override the valet function.

While the present invention has been discussed with an exemplary embodiment of the use of an automobile, the teachings of the present invention are applicable to any other vehicle, such as motorcycles, off-road recreational vehicles, watercrafts or airplanes.

In addition, while at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for restricting access to private data in an automobile comprising:
identifying a user classification;
setting a state of an automobile security system based on the user classification; and
restricting access to private data based on the state of the automotive security system.

2. The method of claim 1 wherein the step of identifying a user classification comprises identifying the user classification based on an indicator stored in an automotive key.

3. The method of claim 1 wherein the step of identifying a user classification comprises identifying the user classification based on an indicator stored on a key fob.

4. The method of claim 1 wherein the step of identifying a user classification comprises identifying the user classification based on a manually entered code.

5. The method of claim 1 wherein the step of identifying a user classification comprises identifying the user classification based on detection of a wireless device.

6. The method of claim 1 wherein the step of restricting access further comprises allowing unrestricted access to private data if the automotive security system is in a full access state.

7. The method of claim 1 wherein the step of restricting access further comprises allowing access to some private data if the automotive security system is in an enhanced valet state.

8. The method of claim 1 wherein the step of restricting access further comprises denying access to all private data if the automotive security system is in a lockdown state.

9. The method of claim 1 further comprising the step of providing an override to allow service personal to bypass the restrictions to private data.

10. The method of claim 8 wherein the step of setting the information state to a lockdown state further comprising setting a lockdown state if an enhanced valet state has been set and a lockdown indicator is set.

11. A system for determining access to private data comprising:
means for identifying a class of user;
means for selecting an information access state based on the class of user coupled to the means for identifying;
means for restricting access to private data, based, at least in part on the information access state.

12. The system of claim 11 wherein the class of user is identified based on an indicator stored in an automotive key.

13. The system of claim 11 wherein the class of user is identified based on an indicator stored on a key fob.

14. The system of claim 11 wherein the class of user is identified based on a manually entered code.

15. The system of claim 11 wherein the class of user is identified based on detection of a short range wireless device.

16. The system of claim 11 wherein the information access state is set to a full access state if the automotive user is allowed unrestricted access to private data.

17. The system of claim 11 wherein the information access state is set to an enhanced valet state if the automotive user is allowed restricted access to private data.

18. The system of claim 11 wherein the information access state is set to a lockdown state if the automotive user is denied access to private data.

19. The system of claim 11 further comprising an override to allow service personal to access private data.

20. The system of claim 18 wherein the lockdown state is set if the enhanced valet state has been set and a lockdown indicator selected.
